(19) United States
(12) Patent Application Publication
(10) Pub. No.: US 2019/0160600 A1
(43) Pub. Date: May 30, 2019

(54) METHOD OF MANUFACTURING EXHAUST-PIPE-FREE VAPOR CHAMBER

(71) Applicant: TAI-SOL ELECTRONICS CO., LTD., Taipei City (TW)

(72) Inventors: Chuan-Chi TSENG, TAIPEI CITY (TW); Wen-Ching LIAO, TAIPEI CITY (TW); Ming-Quan CUI, WUJIANG CITY (CN)

(21) Appl. No.: 15/863,735

(22) Filed: Jan. 5, 2018

(30) Foreign Application Priority Data
Nov. 24, 2017 (TW) 106140971

(51) Int. Cl. B23K 28/02; B23K 9/16; B23K 9/32; B23K 37/04

(52) U.S. Cl. CPC B23K 28/02; B23K 37/04; B23K 9/32; B23K 9/16

(57) ABSTRACT

A method of manufacturing an exhaust-pipe-free vapor chamber includes the steps of: preparing: placing two boards one above the other to form therebetween a receiving space, placing a wick in the receiving space, and sintering the wick to at least one of the boards, wherein the boards each have an extension plate extending outward from an end of the board, allowing the boards and extension plates to form a tunnel which an exhaust pipe is inserted into; water feeding and gas removing; sealing: clamping portions of the boards and extension plates by a sealing clamp, but not clamping the exhaust pipe, wherein the clamped portions correspond in position to the tunnel and are compressed such that a portion of the tunnel is compressed and sealed; cutting: cutting off an external, remaining portion not clamped by the sealing clamp; and welding: welding and sealing a gap not yet been brazed.

### BACKGROUND OF THE INVENTION

### 1. Field of the Invention

The present invention relates to vapor chambers and, more particularly, to a method of manufacturing an exhaust-pipe-free vapor chamber.

### 2. Description of Related Art

Conventional vapor chambers are usually equipped with exhaust pipes. For instance, Taiwan patent 1599755 discloses a vapor chamber with an exhaust pipe (shown on the left of element 11b in FIG. 1 of TW 1599755). The diameter of the exhaust pipe is larger than the thickness of the vapor chamber which is designed to be super-thin, causing operation-related problems.

Furthermore, the exhaust pipe protrudes from the outer edges of boards of the vapor chamber. As a result, collisions or poor soldering processes cause cracks to be formed between the exhaust pipe and vapor chamber. Ambient air intrudes into the vapor chamber through the cracks; hence, the liquid-vapor equilibrium and vacuum degree inside the vapor chamber are undermined, causing the vapor chamber to malfunction and thus fail to work properly.

Exhaust pipes are often omitted from drawings filed together with patent application documents which disclose, and are directed to, vapor chambers, because the exhaust pipes are not essential technical features of the vapor chambers, even though the exhaust pipes are required for the vapor chambers.

To prevent vapor chambers from malfunctioning for the aforesaid reason, it is desirable to provide a method of removing an exhaust pipe.

### BRIEF SUMMARY OF THE INVENTION

It is an objective of the present invention to provide a method of manufacturing an exhaust-pipe-free vapor chamber by removing an exhaust pipe during the manufacturing process such that the vapor chamber thus manufactured does not have any exhaust pipe, so as to not only spare the vapor chamber a thickness limitation otherwise caused by an exhaust pipe but also prevent the vapor chamber from malfunctioning because of collisions.

In order to achieve the above and other objectives, the present invention provides a method of manufacturing an exhaust-pipe-free vapor chamber, comprising the steps of: A) preparing: placing two boards one above the other to form therebetween a receiving space, placing a wick in the receiving space, and sintering the wick to at least one of the two boards, wherein the two boards each have an extension plate extending outward from an end of the board by a predetermined length, with the two extension plates overlapping, adjoining portions of each said board and the extension plate thereof arch outward in a direction perpendicular thereto and thus form a groove of a predetermined length on inward sides of the adjoining portions, with the two boards overlapping and the two extension plates overlapping, the two grooves together form a tunnel, allowing the receiving space and an outside to be in communication with each other by the tunnel, wherein an exhaust pipe is inserted into the tunnel from outward ends of the two extension plates by a predetermined depth, wherein a gap between outer edges of the two boards and a gap between outer edges of the two extension plates are brazed and sealed, and a gap between the exhaust pipe and the two extension plates is also brazed and sealed; B) water feeding and gas removing: feeding water to the receiving space by the tunnel and removing gas from the receiving space by the exhaust pipe, wherein the water feeding either precedes or follows the gas removing; C) sealing: clamping portions of the two boards and portions of the two extension plates by a sealing clamp, but not clamping the exhaust pipe, wherein the clamped portions correspond in position to a lengthwise segment of the tunnel and are compressed such that the two grooves disappear because of the compression, allowing at least a portion of the tunnel to be compressed and sealed; D) cutting: cutting off an external, remaining portion not clamped by the sealing clamp and forming at a point of the cutting a gap which has not yet been brazed; and E) welding: welding and sealing the gap which has not yet been brazed.

The exhaust pipe is removed in the cutting step. The welding step marks the end of the manufacturing process of the vapor chamber. Hence, the vapor chamber thus manufactured does not have any exhaust pipe, so as to not only spare the vapor chamber a thickness limitation otherwise caused by an exhaust pipe but also prevent the vapor chamber from malfunctioning because of collisions.

### BRIEF DESCRIPTION OF THE DRAWINGS

FIG. 1 is a schematic view of the process flow of a method of manufacturing an exhaust-pipe-free vapor chamber according to the first preferred embodiment of the present invention;

FIG. 2 is an exploded view according to the first preferred embodiment of the present invention;

FIG. 3 is a schematic view of assembly in a preparing step according to the first preferred embodiment of the present invention;

FIG. 4 is a cross-sectional view taken along line 4-4 in FIG. 3:

FIG. 5 is a schematic view of operation in a sealing step according to the first preferred embodiment of the present invention:

FIG. 6 is another schematic view of operation in a cutting step according to the first preferred embodiment of the present invention:

FIG. 7 is a schematic view of a result of welding according to the first preferred embodiment of the present invention;

FIG. 8 is a partial enlarged view FIG. 7, showing welded outward ends of extension plates;

FIG. 9 is a schematic view of assembly in a preparing step according to the second preferred embodiment of the present invention;

FIG. 10 is a schematic view of a result of welding according to the second preferred embodiment of the present invention;

FIG. 11 is a schematic view of operation in a sealed and cut state according to the third preferred embodiment of the present invention; and

FIG. 12 is a schematic view of a result of welding according to the third preferred embodiment of the present invention.

### BRIEF DESCRIPTION OF THE SEVERAL VIEWS OF THE DRAWINGS

Technical features of the present invention is illustrated by preferred embodiments, depicted by accompanying drawings, and described below.

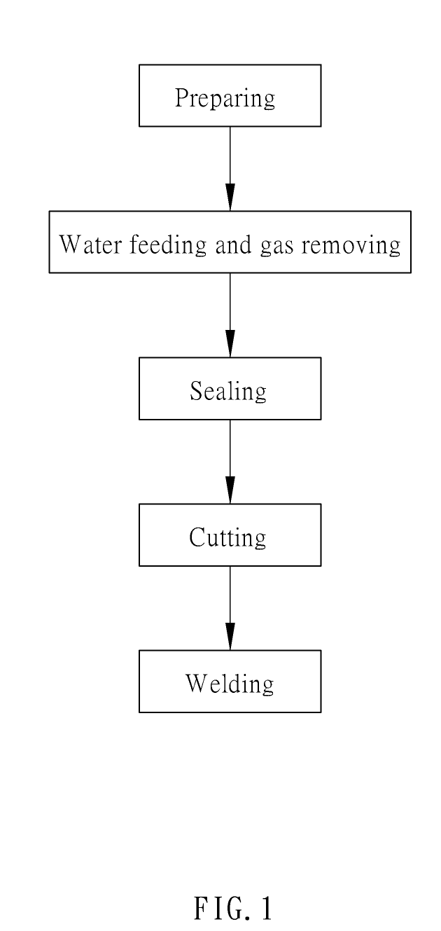

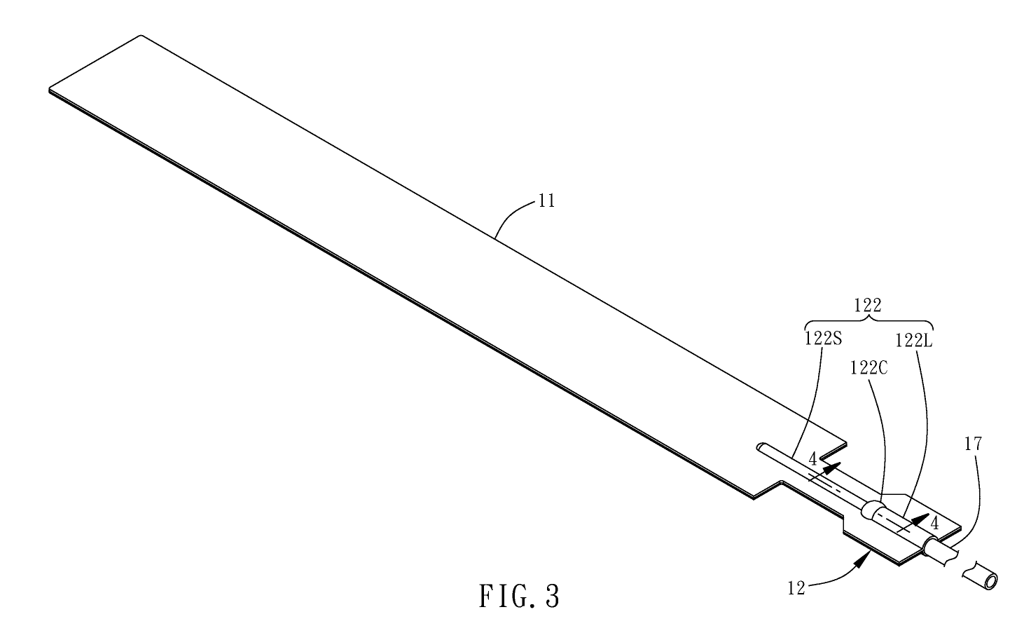

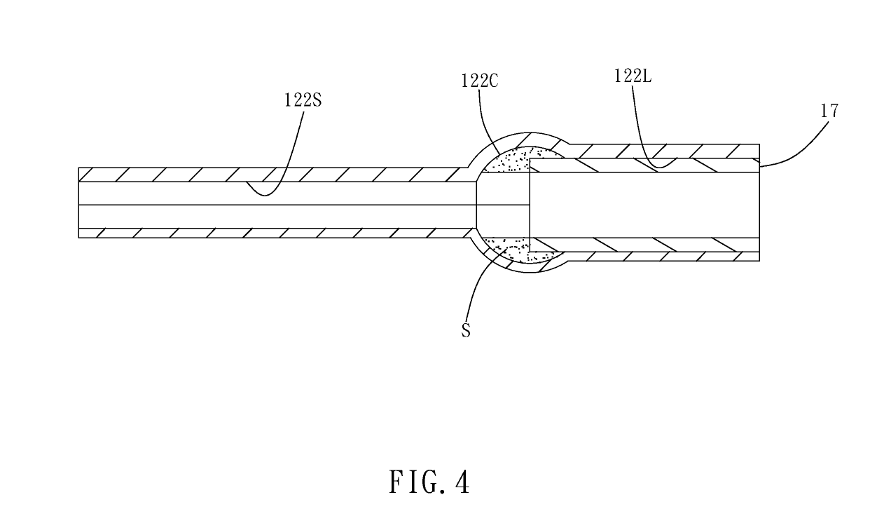

Referring to FIG. 1 through FIG. 8, there are shown diagrams about a method of manufacturing an exhaust-pipe-free vapor chamber according to the first preferred embodiment of the present invention. The method comprises a preparing step, a water feeding and gas removing step, a compressing step, a cutting step, and a welding step, which are describe below.

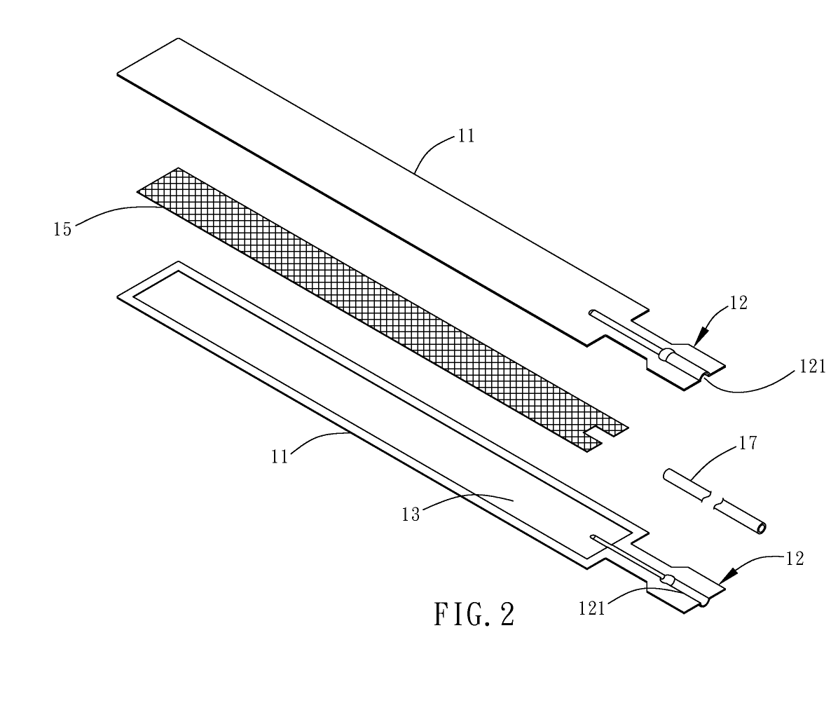

A) preparing: placing two boards 11 one above the other to form therebetween a receiving space 13, placing a wick 15 in the receiving space 13, and sintering the wick 15 to at least one of the two boards 11, as shown in FIG. 2 through FIG. 4. Sintering a wick to one board 11 or two boards 11 is attributed to the prior art and thus directly comprehensible to persons skilled in the art; hence, it is not described in detail herein. Each board 11 has an extension plate 12 extending outward from one end of the board 11 by a predetermined length. The two extension plates 12 overlap. Adjoining portions of each board 11 and the extension plate 12 thereof arch outward in the direction perpendicular thereto and thus form a groove 121 of a predetermined length on the inward sides of the adjoining portions. With the two boards 11 overlapping and the two extension plates 12 overlapping, the two grooves 121 together form a tunnel 122. The receiving space 13 and the outside are in communication with each other by the tunnel 122. An exhaust pipe 17 is inserted into the tunnel 122 from the outward ends of the two extension plates 12 by a predetermined depth. The gap between the outer edges of the two boards 11 and the gap between the outer edges of the two extension plates 12 are brazed and sealed. The gap between the exhaust pipe 17 and the two extension plates 12 is also brazed and sealed.

In practice, the tunnel 122 in step A is of a uniform diameter lengthwise. However, to achieve a better effect, the tunnel 122 in this embodiment comprises a large-diameter segment 122L and a small-diameter segment 122S which are connected and communicated with each other. The large-diameter segment 122L extends from a junction of the large-diameter segment 122L and the small-diameter segment 122S toward the outward ends of the two extension plates 12. The small-diameter segment 122S extends from the junction toward the inward ends of the two extension plates 12. The small-diameter segment 122S is of a smaller diameter than the large-diameter segment 122L. The aforesaid arrangement and structure is intended to allow the large-diameter segment 122L to receive the exhaust pipe 17 and then allow the small-diameter segment 122S to be subsequently, easily compressed and sealed, thereby rendering the ensuing steps easy. Given sufficient width of the two extension plates 12, the large-diameter segment 122L extends from a junction of the large-diameter segment 122L and the small-diameter segment 122S toward the inward ends of the two extension plates 12, whereas the small-diameter segment 122S extends from the junction toward the outward ends of the two extension plates 12; hence, the small-diameter segment 122S receives the exhaust pipe 17. The aforesaid arrangement and structure can be inferred from FIG. 2 through FIG. 4 and thus is not shown in the accompanying drawings.

In step A, a container 122C is formed at the junction of the large-diameter segment 122L and the small-diameter segment 122S. The container 122C is of a larger diameter than the large-diameter segment 122L. To be received in the tunnel 122, the exhaust pipe 17 must has its surface covered uniformly with solder, such as copper paste. The solder must cover the surface of the exhaust pipe 17 and is filled between the two boards 11 and extension plates 12 such that the exhaust pipe 17 is brazed and fixed in placed. Therefore, during the brazing process, surplus solder stays in the container 122C rather than enters or clogs the small-diameter segment 122S, and thus the tunnel 122 is always open. However, in practice, the container 122C is dispensable, as long as the amount of solder in use is precise enough to prevent the tunnel 122 from clogging.

B) water feeding and gas removing: feeding water to the receiving space 13 by the tunnel 122 and removing gas from the receiving space 13 by the exhaust pipe 17, wherein the water feeding process either precedes or follows the gas removing process.

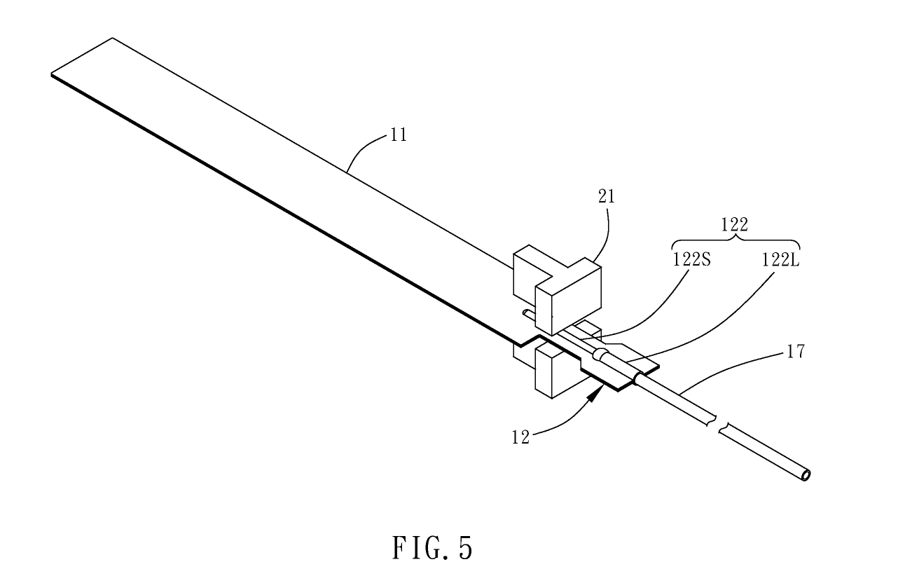

C) sealing: clamping portions of the two boards 11 and portions of the two extension plates 12 by a sealing clamp 21 (as shown in FIG. 5 which depicts that the sealing clamp 21 clamps the two extension plates 12), but not clamping the exhaust pipe 17, wherein the clamped portions correspond in position to a lengthwise segment of the tunnel 122 and are compressed but not beyond the small-diameter segment 122S of the tunnel 122 such that the grooves 121 attributed to the two extension plates 12 and corresponding in position to the small-diameter segment 122S disappear because of the compression, allowing the tunnel 122 corresponding in position to the small-diameter segment 122S to be compressed and sealed. The exhaust pipe 17 is confined to the large-diameter segment 122L and thus is not clamped by the sealing clamp 21.

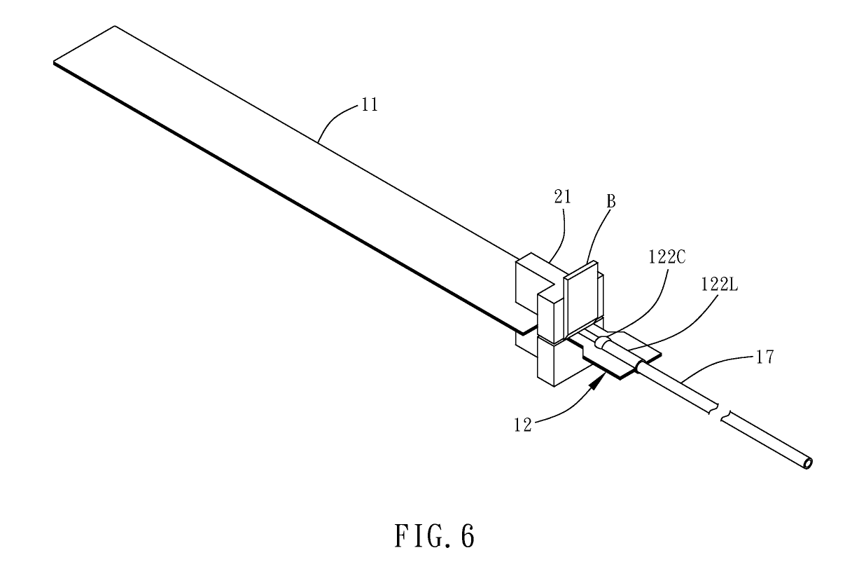

D) cutting: cutting off the external, remaining portion of the two boards 11 and the two extension plates 12, which is not clamped by the sealing clamp 21, (as shown in FIG. 6, which is illustrative of a blade B), and forming at the point of the cutting a gap which has not yet been brazed, wherein after the cutting process the two extension plates 12 remain intact along part of their length. Hence, portions of the two extension plates 12, which correspond in position to the large-diameter segment 122L and the container 122C, are cut off. Furthermore, the exhaust pipe 17 is cut off together with the large-diameter segment 122L. Alternatively, the exhaust pipe 17 is removed before the aforesaid cutting process begins.

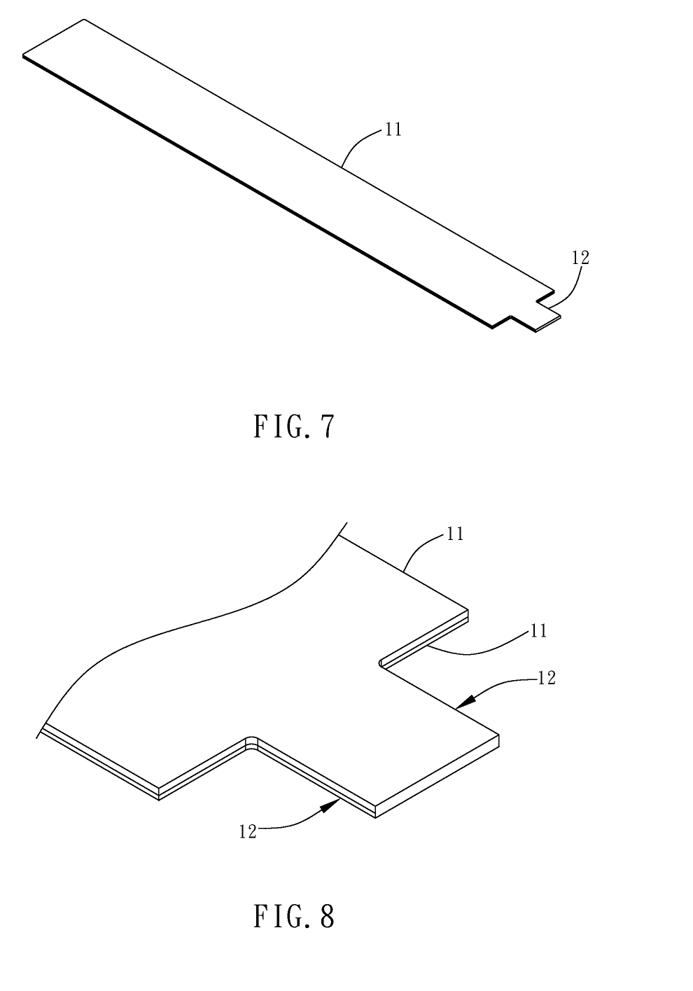

E) welding: welding and sealing the gap which has not yet been brazed, as shown in FIG. 7 and FIG. 8. In this step, welding is exemplified by argon arc welding.

Upon completion of the aforesaid steps, the vapor chamber manufactured according to the present invention does not have the exhaust pipe 17, so as to not only spare the vapor chamber a thickness limitation otherwise caused by an exhaust pipe but also prevent the vapor chamber from malfunctioning because of collisions. Since the vapor chamber manufactured according to the present invention does not have the exhaust pipe 17, it meets the specification requirement of super-thin vapor chambers.

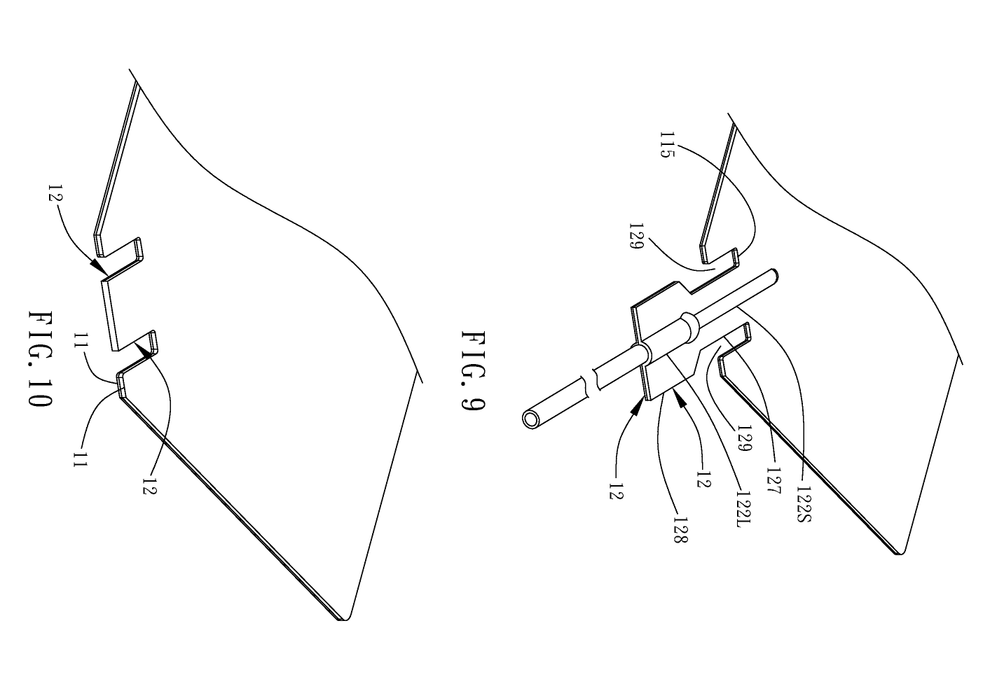

Referring to FIG. 9 and FIG. 10, a method of manufacturing an exhaust-pipe-free vapor chamber according to the second preferred embodiment of the present invention is distinguished from that of the first preferred embodiment as follows:

In step A, the edges of the two boards 11 retract to form a concave portion 115. The two extension plates 12 extend outward from the bottom edge of the concave portion 115. The portion of the extension plates 12, which is inside the concave portion 115, is defined as an inner section 127. The portion of the extension plates 12, which is outside the concave portion 115, is defined as an outer section 128. The large-diameter segment 122L is located at the outer section 128, and the small-diameter segment 122S is located at the inner section 127. The two lateral edges of the inner section 127 are separated from the two lateral edges of the concave portion 115 by a predetermined distance, to therefore form two hollowed-out portions 129, respectively. The two hollowed-out portions 129 provide room for lateral extension of the two extension plates 12. The two extension plates 12 are likely to extend laterally when clamped by a sealing clamp (not shown) and compressed.

In step C, the sealing clamp must clamp at least a portion of the inner section 127. In the second preferred embodiment, the sealing clamp clamps the inner section 127 entirely, for an exemplary purpose.

In step E, the outward edges of the two extension plates 12 either go beyond or do not go beyond the lateral edges of the two boards 11. In the second preferred embodiment, the outward edges of the two extension plates 12 are flush with the lateral edges of the two boards 11 for an exemplary purpose.

In the second preferred embodiment, the concave portion 115 ensures that the outer edges of the extension plates 12 do not go beyond the lateral edges of the two boards 11 to further reduce the chance that the extension plates 12 will collide with an external object, thereby protecting the extension plates 12.

The other technical features and achievable advantages of the second preferred embodiment are substantially the same as those of the first preferred embodiment and thus are not described again for the sake of brevity.

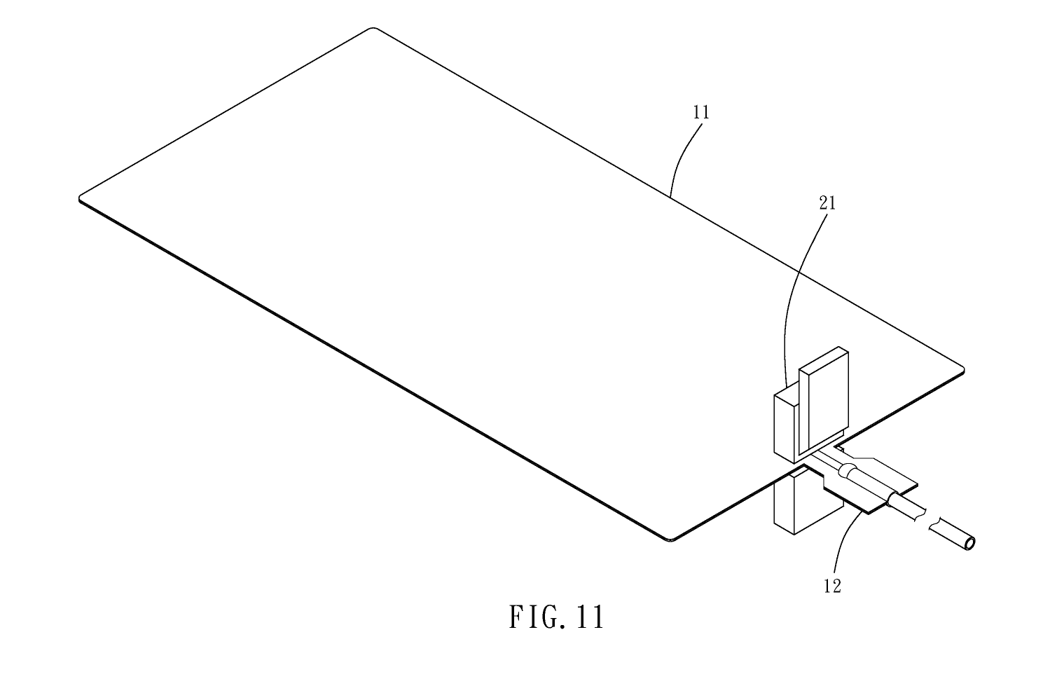

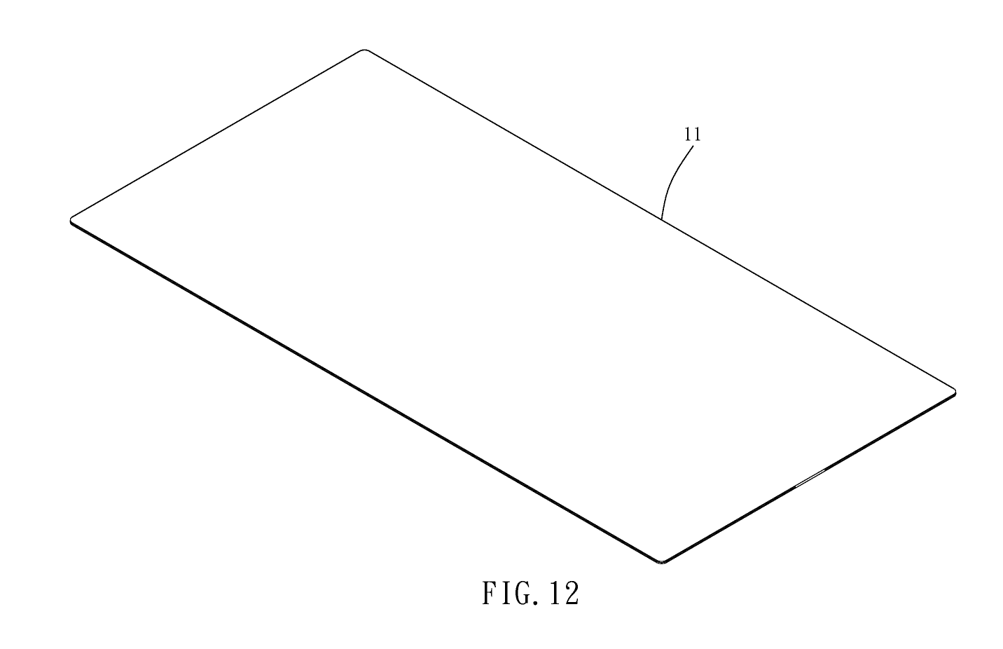

Referring to FIG. 11 and FIG. 12, a method of manufacturing an exhaust-pipe-free vapor chamber according to the third preferred embodiment of the present invention is distinguished from that of the first preferred embodiment as follows:

In step C, the sealing clamp 21 clamps the two boards 11 rather than the two extension plates 12, and edges of the two boards 11 are trimmed, as shown in FIG. 11.

In step D, by the time the cutting process ends, the two extension plates 12 have been cut off, whereas lateral edges of the two boards 11 which remain are trimmed.

Therefore, despite the absence of protrusions on edges of the vapor chamber thus manufactured, the vapor chamber of the third preferred embodiment still achieves the same advantages as that of the first preferred embodiment.

The other technical features and achievable advantages of the third preferred embodiment are substantially the same as those of the first preferred embodiment and thus are not described again for the sake of brevity.

What is claimed is:

1. A method of manufacturing an exhaust-pipe-free vapor chamber, comprising the steps of:
A) preparing: placing two boards one above the other to form therebetween a receiving space, placing a wick in the receiving space, and sintering the wick to at least one of the two boards, wherein the two boards each have an extension plate extending outward from an end of the board by a predetermined length, with the two extension plates overlapping, adjoining portions of each said board and the extension plate thereof arch outward in a direction perpendicular thereto and thus form a groove of a predetermined length on inward sides of the adjoining portions, with the two boards overlapping and the two extension plates overlapping, the two grooves together form a tunnel, allowing the receiving space and an outside to be in communication with each other by the tunnel, wherein an exhaust pipe is inserted into the tunnel from outward ends of the two extension plates by a predetermined depth, wherein a gap between outer edges of the two boards and a gap between outer edges of the two extension plates are brazed and sealed, and a gap between the exhaust pipe and the two extension plates is also brazed and sealed;
B) water feeding and gas removing: feeding water to the receiving space by the tunnel and removing gas from the receiving space by the exhaust pipe, wherein the water feeding either precedes or follows the gas removing;
C) sealing: clamping portions of the two boards and portions of the two extension plates by a sealing clamp, but not clamping the exhaust pipe, wherein the clamped portions correspond in position to a lengthwise segment of the tunnel and are compressed such that the two grooves disappear because of the compression, allowing at least a portion of the tunnel to be compressed and sealed;
D) cutting: cutting off an external, remaining portion not clamped by the sealing clamp and forming at a point of the cutting a gap which has not yet been brazed; and
E) welding: welding and sealing the gap which has not yet been brazed.

2. The method of claim 1, wherein: in step A, edges of the two boards retract to form a concave portion, and the two extension plates extend outward from a bottom edge of the concave portion, allowing an inner section to be defined as a portion of the extension plates, the portion being inside the concave portion, and allowing an outer section to be defined as a portion of the extension plates, the portion being outside the concave portion.

3. The method of claim 2, wherein: two lateral edges of the inner section are separated from two lateral edges of the concave portion by a predetermined distance to form two hollowed-out portions, respectively.

4. The method of claim 2, wherein the sealing clamp clamps at least a portion of the inner section in step C, and outward edges of the two extension plates do not go beyond lateral edges of the two boards in step E.

5. The method of claim 2, wherein: in step A, the tunnel comprises a large-diameter segment and a small-diameter segment which are connected and communicated with each other, the small-diameter segment being of a smaller diameter than the large-diameter segment and being located at the inner section, and the large-diameter segment being located at the outer section.

6. The method of claim 5, wherein a container is formed at a junction of the large-diameter segment and the small-diameter segment and is of a larger diameter than the large-diameter segment.

7. The method of claim 1, wherein, in step E, the welding is exemplified by argon arc welding.

8. The method of claim 1, wherein, in step A, the tunnel comprises a large-diameter segment and a small-diameter segment which are connected and communicated with each other, the small-diameter segment being of a smaller diameter than the large-diameter segment, with the large-diameter segment extending from a junction of the large-diameter segment and the small-diameter segment toward the outward ends of the two extension plates, and the small-diameter segment extending from the junction toward inward ends of the two extension plates.

9. The method of claim 8, wherein a container is formed at the junction of the large-diameter segment and the small-diameter segment and is of a diameter larger than the large-diameter segment.

10. The method of claim 1, wherein the sealing clamp clamps the two extension plates in step C, and the two extension plates remain intact along part of their length after the cutting process in step D.

11. The method of claim 1, wherein the sealing clamp clamps the two boards rather than the two extension plates in step C, and the two extension plates are cut off during the cutting process in step D.
